(19) United States
(12) Patent Application Publication
(10) Pub. No.: US 2024/0335745 A1
(43) Pub. Date: Oct. 10, 2024

(54) Two-View Geometry Scoring without Correspondences

(71) Applicant: Niantic, Inc., San Francisco, CA (US)

(72) Inventors: Axel Barroso-Laguna, London (GB); Eric Brachmann, Hanover (DE); Daniyar Turmukhambetov, London (GB)

(21) Appl. No.: 18/627,798

(22) Filed: Apr. 5, 2024

Related U.S. Application Data
(60) Provisional application No. 63/495,044, filed on Apr. 7, 2023.

(51) Int. Cl. A63F 13/52; A63F 13/216; A63F 13/655; G06T 7/00; G06T 7/73; G06T 19/00

(52) U.S. Cl. CPC A63F 13/52; A63F 13/655; G06T 7/0002; G06T 7/73; G06T 19/00; A63F 13/216; G06T 2207/20081

(57) ABSTRACT

A machine learned model may calculate a relative pose between a pair of overlapping images of a scene. The model may be applied to predict one or more errors (e.g., translation error and/or rotation error) in the relative pose between the pair of overlapping images. The model may leverage epipolar geometry to compare features of the overlapping images in a dense manner. For example, the two-view geometry model may incorporate the epipolar geometry into an attention layer of a neural network for one or more different fundamental matrix hypotheses. The model may output one or more predicted errors for the pair of images along with a proposed fundamental matrix hypothesis. A client device may select a fundamental matrix associated with the lowest predicted one or more errors. The client device may then display content that accounts for the predicted one or more errors.

### CROSS-REFERENCE TO RELATED APPLICATIONS

This application claims the benefit of U.S. Provisional Patent Application No. 63/495,044, filed Apr. 7, 2023, which is incorporated by reference.

### BACKGROUND

### 1. Technical Field

The subject matter described relates generally to pose determination, and, in particular, to determining the relative pose between two images of a scene.

### 2. Problem

How to determine the relative camera pose between two images is one of the cornerstone challenges in computer vision. Determining accurate camera poses underpin numerous pipelines such as Structure-from-Motion, odometry, simultaneous localization and mapping (SLAM), and visual relocalization, among others. Much of the time, an accurate fundamental matrix can be estimated by existing means, but the failures are prevalent enough to hurt real-world tasks. When particular techniques will fail to provide accurate relative pose information is also difficult to anticipate. There is thus a need for more accurate approaches to determining the relative pose of two images of a scene.

### SUMMARY

The present disclosure describes techniques for two-view geometry scoring without using correspondences. A client device may use a machine learned model (e.g., a two-view geometry model) to calculate a relative pose between a pair of overlapping images of a scene. The machine learned model may be applied to predict one or more errors (e.g., angular translation error and/or rotation error) in the relative pose between the pair of overlapping images. The machine learned model may leverage epipolar geometry to compare features of the overlapping images in a dense manner. For example, the machine learned model may incorporate the epipolar geometry into an attention layer of a neural network for one or more different fundamental matrix hypotheses. The two-view geometry model may output one or more predicted errors for the pair of images along with a proposed fundamental matrix hypothesis. The client device may select a fundamental matrix associated with the lowest predicted one or more errors. The client device may display content that accounts for the one or more errors of the selected fundamental matrix.

In some aspects, the techniques described herein relate to a computer-implemented method including: receiving a pair of overlapping images of a scene; calculating a relative pose between the pair of overlapping images; applying a two-view geometry model to predict an error in the relative pose between the pair of overlapping images; and providing content for display at a client device accounting for the error.

In some aspects, the techniques described herein relate to a computer program product including a non-transitory computer readable storage medium having instructions encoded thereon that, when executed by a processor of a client device, cause the client device to: receive a pair of overlapping images of a scene; calculate a relative pose between the pair of overlapping images; apply a two-view geometry model to predict an error in the relative pose between the pair of overlapping images; and present content that accounts for the error.

In some aspects, the techniques described herein relate to a client device including: one or more cameras configured to capture a pair of overlapping images of a scene; a display configured to present content; a processor; and a non-transitory computer readable storage medium having instructions encoded thereon that, when executed by the processor, cause the processor to: calculate a relative pose between the pair of overlapping images, apply a two-view geometry model to predict an error in the relative pose between the pair of overlapping images, and instruct the display to present content, wherein the content accounts for the error.

### BRIEF DESCRIPTION OF THE DRAWINGS

FIG. 1 depicts a representation of a virtual world having a geography that parallels the real world, according to one embodiment.

FIG. 2 depicts an exemplary game interface of a parallel reality game, according to one embodiment.

FIG. 3 is a block diagram of a networked computing environment suitable for providing two-view geometry scoring, according to one embodiment.

FIG. 4 is a block diagram of a two-view geometry model, according to one or more embodiments.

FIG. 5 is a flowchart describing an example method of using two-view geometry scoring in the generation of content, according to one embodiment.

FIG. 6 illustrates an example computer system suitable for use in the networked computing environment of FIG. 1, according to one embodiment.

### DETAILED DESCRIPTION

The figures and the following description describe certain embodiments by way of illustration only. One skilled in the art will recognize from the following description that alternative embodiments of the structures and methods may be employed without departing from the principles described. Wherever practicable, similar or like reference numbers are used in the figures to indicate similar or like functionality. Where elements share a common numeral followed by a different letter, this indicates the elements are similar or identical. A reference to the numeral alone generally refers to any one or any combination of such elements, unless the context indicates otherwise.

Various embodiments are described in the context of a parallel reality game that includes augmented reality content in a virtual world geography that parallels at least a portion of the real-world geography such that player movement and actions in the real-world affect actions in the virtual world. The subject matter described is applicable in other situations where determining the relative pose between two images of a scene is desirable. In addition, the inherent flexibility of computer-based systems allows for a great variety of possible configurations, combinations, and divisions of tasks and functionality between and among the components of the system.

### Example Location-Based Parallel Reality Game

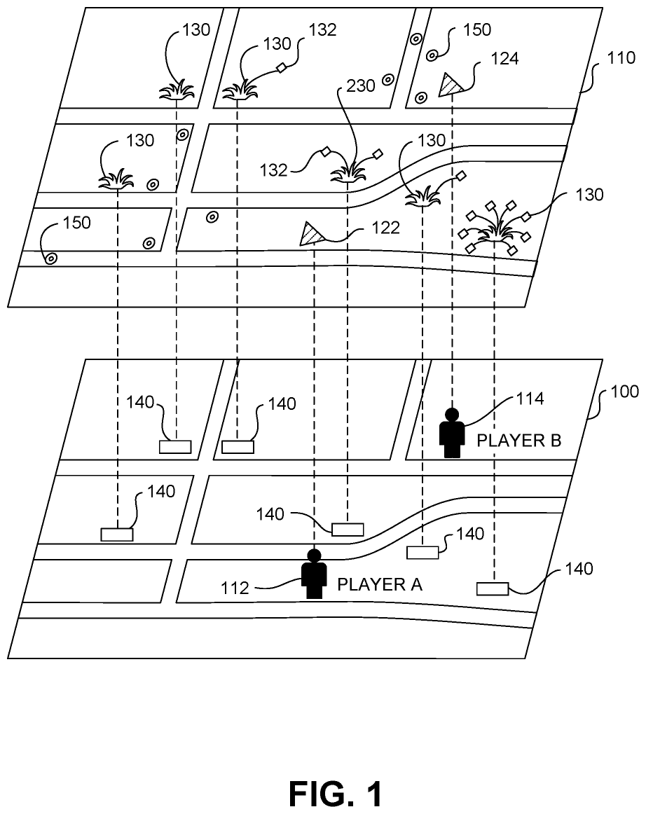

FIG. 1 is a conceptual diagram of a virtual world 110 that parallels the real world 100. The virtual world 110 can act as the game board for players of a parallel reality game. As illustrated, the virtual world 110 includes a geography that parallels the geography of the real world 100. In particular, a range of coordinates defining a geographic area or space in the real world 100 is mapped to a corresponding range of coordinates defining a virtual space in the virtual world 110. The range of coordinates in the real world 100 can be associated with a town, neighborhood, city, campus, locale, a country, continent, the entire globe, or other geographic area. Each geographic coordinate in the range of geographic coordinates is mapped to a corresponding coordinate in a virtual space in the virtual world 110.

A player's position in the virtual world 110 corresponds to the player's position in the real world 100. For instance, player A located at position 112 in the real world 100 has a corresponding position 122 in the virtual world 110. Similarly, player B located at position 114 in the real world 100 has a corresponding position 124 in the virtual world 110. As the players move about in a range of geographic coordinates in the real world 100, the players also move about in the range of coordinates defining the virtual space in the virtual world 110. In particular, a positioning system (e.g., a GPS system, a localization system, or both) associated with a mobile computing device carried by the player can be used to track a player's position as the player navigates the range of geographic coordinates in the real world 100. Data associated with the player's position in the real world 100 is used to update the player's position in the corresponding range of coordinates defining the virtual space in the virtual world 110. In this manner, players can navigate along a continuous track in the range of coordinates defining the virtual space in the virtual world 110 by simply traveling among the corresponding range of geographic coordinates in the real world 100 without having to check in or periodically update location information at specific discrete locations in the real world 100.

The location-based game can include game objectives requiring players to travel to or interact with various virtual elements or virtual objects scattered at various virtual locations in the virtual world 110. A player can travel to these virtual locations by traveling to the corresponding location of the virtual elements or objects in the real world 100. For instance, a positioning system can track the position of the player such that as the player navigates the real world 100, the player also navigates the parallel virtual world 110. The player can then interact with various virtual elements and objects at the specific location to achieve or perform one or more game objectives.

A game objective may have players interacting with virtual elements 130 located at various virtual locations in the virtual world 110. These virtual elements 130 can be linked to landmarks, geographic locations, or objects 140 in the real world 100. The real-world landmarks or objects 140 can be works of art, monuments, buildings, businesses, libraries, museums, or other suitable real-world landmarks or objects. Interactions include capturing, claiming ownership of, using some virtual item, spending some virtual currency, etc. To capture these virtual elements 130, a player travels to the landmark or geographic locations 140 linked to the virtual elements 130 in the real world and performs any necessary interactions (as defined by the game's rules) with the virtual elements 130 in the virtual world 110. For example, player A may have to travel to a landmark 140 in the real world 100 to interact with or capture a virtual element 130 linked with that particular landmark 140. The interaction with the virtual element 130 can require action in the real world, such as taking a photograph or verifying, obtaining, or capturing other information about the landmark or object 140 associated with the virtual element 130.

Game objectives may require that players use one or more virtual items that are collected by the players in the location-based game. For instance, the players may travel the virtual world 110 seeking virtual items 132 (e.g. weapons, creatures, power ups, or other items) that can be useful for completing game objectives. These virtual items 132 can be found or collected by traveling to different locations in the real world 100 or by completing various actions in either the virtual world 110 or the real world 100 (such as interacting with virtual elements 130, battling non-player characters or other players, or completing quests, etc.). In the example shown in FIG. 1, a player uses virtual items 132 to capture one or more virtual elements 130. In particular, a player can deploy virtual items 132 at locations in the virtual world 110 near to or within the virtual elements 130. Deploying one or more virtual items 132 in this manner can result in the capture of the virtual element 130 for the player or for the team/faction of the player.

In one particular implementation, a player may have to gather virtual energy as part of the parallel reality game. Virtual energy 150 can be scattered at different locations in the virtual world 110. A player can collect the virtual energy 150 by traveling to (or within a threshold distance of) the location in the real world 100 that corresponds to the location of the virtual energy in the virtual world 110. The virtual energy 150 can be used to power virtual items or perform various game objectives in the game. A player that loses all virtual energy 150 may be disconnected from the game or prevented from playing for a certain amount of time or until they have collected additional virtual energy 150.

According to aspects of the present disclosure, the parallel reality game can be a massive multi-player location-based game where every participant in the game shares the same virtual world. The players can be divided into separate teams or factions and can work together to achieve one or more game objectives, such as to capture or claim ownership of a virtual element. In this manner, the parallel reality game can intrinsically be a social game that encourages cooperation among players within the game. Players from opposing teams can work against each other (or sometime collaborate to achieve mutual objectives) during the parallel reality game. A player may use virtual items to attack or impede progress of players on opposing teams. In some cases, players are encouraged to congregate at real world locations for cooperative or interactive events in the parallel reality game. In these cases, the game server seeks to ensure players are indeed physically present and not spoofing their locations.

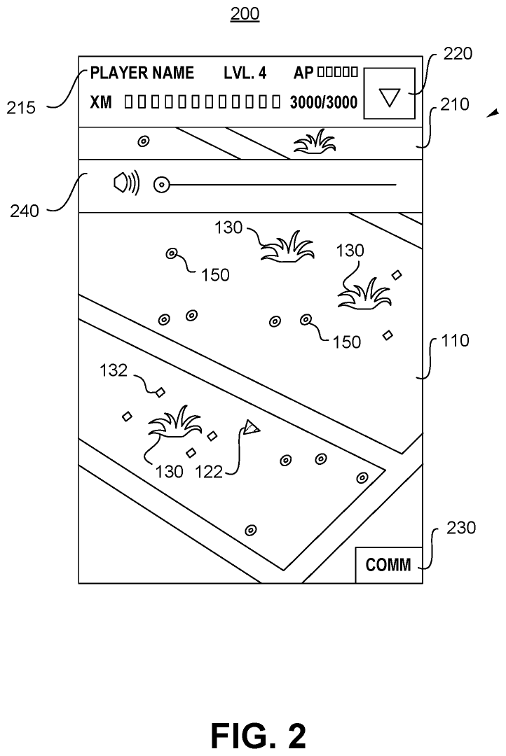

FIG. 2 depicts one embodiment of a game interface 200 that can be presented (e.g., on a player's smartphone) as part of the interface between the player and the virtual world 110. The game interface 200 includes a display window 210 that can be used to display the virtual world 110 and various other aspects of the game, such as player position 122 and the locations of virtual elements 130, virtual items 132, and virtual energy 150 in the virtual world 110. The user interface 200 can also display other information, such as game data information, game communications, player information, client location verification instructions and other information associated with the game. For example, the user interface can display player information 215, such as player name, experience level, and other information. The user interface 200 can include a menu 220 for accessing various game settings and other information associated with the game. The user interface 200 can also include a communications interface 230 that enables communications between the game system and the player and between one or more players of the parallel reality game.

According to aspects of the present disclosure, a player can interact with the parallel reality game by carrying a client device around in the real world. For instance, a player can play the game by accessing an application associated with the parallel reality game on a smartphone and moving about in the real world with the smartphone. In this regard, it is not necessary for the player to continuously view a visual representation of the virtual world on a display screen in order to play the location-based game. As a result, the user interface 200 can include non-visual elements that allow a user to interact with the game. For instance, the game interface can provide audible notifications to the player when the player is approaching a virtual element or object in the game or when an important event happens in the parallel reality game. In some embodiments, a player can control these audible notifications with audio control 240. Different types of audible notifications can be provided to the user depending on the type of virtual element or event. The audible notification can increase or decrease in frequency or volume depending on a player's proximity to a virtual element or object. Other non-visual notifications and signals can be provided to the user, such as a vibratory notification or other suitable notifications or signals.

The parallel reality game can have various features to enhance and encourage game play within the parallel reality game. For instance, players can accumulate a virtual currency or another virtual reward (e.g., virtual tokens, virtual points, virtual material resources, etc.) that can be used throughout the game (e.g., to purchase in-game items, to redeem other items, to craft items, etc.). Players can advance through various levels as the players complete one or more game objectives and gain experience within the game. Players may also be able to obtain enhanced “powers” or virtual items that can be used to complete game objectives within the game.

Those of ordinary skill in the art, using the disclosures provided, will appreciate that numerous game interface configurations and underlying functionalities are possible. The present disclosure is not intended to be limited to any one particular configuration unless it is explicitly stated to the contrary.

### Example Gaming System

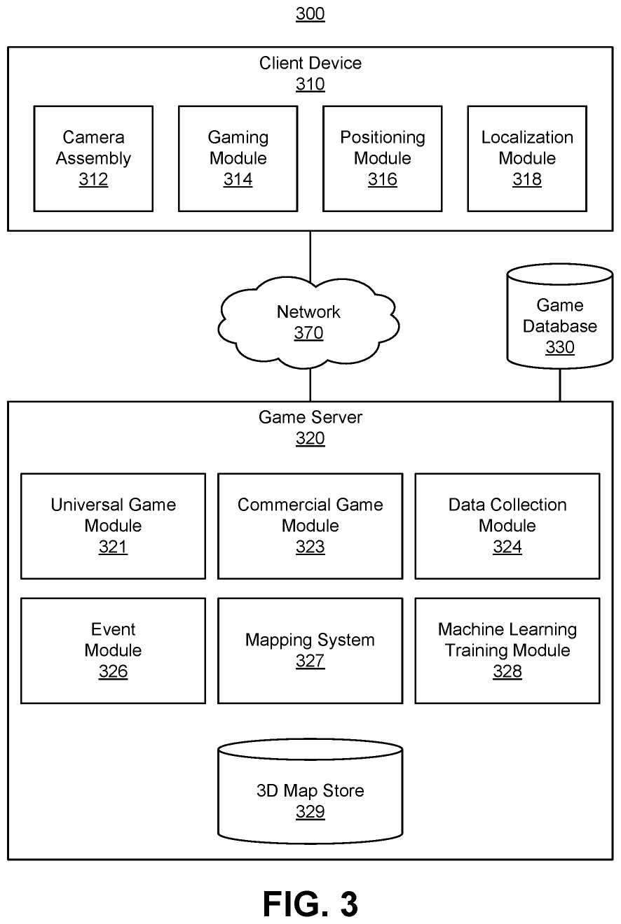

FIG. 3 illustrates one embodiment of a networked computing environment 300. The networked computing environment 300 uses a client-server architecture, where a game server 320 communicates with a client device 310 over a network 370 to provide a parallel reality game to a player at the client device 310. The networked computing environment 300 also may include other external systems such as sponsor/advertiser systems or business systems. Although only one client device 310 is shown in FIG. 3, any number of client devices 310 or other external systems may be connected to the game server 320 over the network 370. Furthermore, the networked computing environment 300 may contain different or additional elements and functionality may be distributed between the client device 310 and the game server 320 in different manners than described below.

The networked computing environment 300 provides for the interaction of players in a virtual world having a geography that parallels the real world. In particular, a geographic area in the real world can be linked or mapped directly to a corresponding area in the virtual world. A player can move about in the virtual world by moving to various geographic locations in the real world. For instance, a player's position in the real world can be tracked and used to update the player's position in the virtual world. Typically, the player's position in the real world is determined by finding the location of a client device 310 through which the player is interacting with the virtual world and assuming the player is at the same (or approximately the same) location. For example, in various embodiments, the player may interact with a virtual element if the player's location in the real world is within a threshold distance (e.g., ten meters, twenty meters, etc.) of the real-world location that corresponds to the virtual location of the virtual element in the virtual world. For convenience, various embodiments are described with reference to “the player's location” but one of skill in the art will appreciate that such references may refer to the location of the player's client device 310.

A client device 310 can be any portable computing device capable for use by a player to interface with the game server 320. For instance, a client device 310 is preferably a portable wireless device that can be carried by a player, such as a smartphone, portable gaming device, augmented reality (AR) headset, cellular phone, tablet, personal digital assistant (PDA), navigation system, handheld GPS system, or other such device. For some use cases, the client device 310 may be a less-mobile device such as a desktop or a laptop computer. Furthermore, the client device 310 may be a vehicle with a built-in computing device.

The client device 310 communicates with the game server 320 to provide sensory data of a physical environment. In one embodiment, the client device 310 includes a camera assembly 312, a gaming module 314, positioning module 316, and localization module 318. The client device 310 also includes a network interface (not shown) for providing communications over the network 370. In various embodiments, the client device 310 may include different or additional components, such as additional sensors, display, and software modules, etc.

The camera assembly 312 includes one or more cameras which can capture image data. The cameras capture image data describing a scene of the environment surrounding the client device 310 with a particular pose (the location and orientation of the camera within the environment). The camera assembly 312 may use a variety of photo sensors with varying color capture ranges and varying capture rates. Similarly, the camera assembly 312 may include cameras with a range of different lenses, such as a wide-angle lens or a telephoto lens. The camera assembly 312 may be configured to capture single images or multiple images as frames of a video. In some embodiments, the camera assembly 312 includes multiple cameras with overlapping fields of view such that an object in a local area of the client device 310 may be imaged at a same time by the multiple cameras. The camera assembly 312 may also include a camera whose images have overlapping areas but at different instances in time (e.g., subsequent image frames).

The client device 310 may also include additional sensors for collecting data regarding the environment surrounding the client device, such as movement sensors, accelerometers, gyroscopes, barometers, thermometers, light sensors, microphones, etc. The image data captured by the camera assembly 312 can be appended with metadata describing other information about the image data, such as additional sensory data (e.g. temperature, brightness of environment, air pressure, location, pose etc.) or capture data (e.g. exposure length, shutter speed, focal length, capture time, etc.).

The gaming module 314 provides a player with an interface to participate in the parallel reality game. The game server 320 transmits game data over the network 370 to the client device 310 for use by the gaming module 314 to provide a local version of the game to a player at locations remote from the game server. In one embodiment, the gaming module 314 presents a user interface on a display of the client device 310 that depicts a virtual world (e.g. renders imagery of the virtual world) and allows a user to interact with the virtual world to perform various game objectives. In some embodiments, the gaming module 314 presents images of the real world (e.g., captured by the camera assembly 312) augmented with virtual elements from the parallel reality game. In these embodiments, the gaming module 314 may generate or adjust virtual content according to other information received from other components of the client device 310. For example, the gaming module 314 may adjust a virtual object to be displayed on the user interface according to a depth map of the scene captured in the image data.

The gaming module 314 can also control various other outputs to allow a player to interact with the game without requiring the player to view a display screen. For instance, the gaming module 314 can control various audio, vibratory, or other notifications that allow the player to play the game without looking at the display screen.

The positioning module 316 can be any device or circuitry for determining the position of the client device 310. For example, the positioning module 316 can determine actual or relative position by using a satellite navigation positioning system (e.g. a GPS system, a Galileo positioning system, the Global Navigation satellite system (GLONASS), the BeiDou Satellite Navigation and Positioning system), an inertial navigation system, a dead reckoning system, IP address analysis, triangulation and/or proximity to cellular towers or Wi-Fi hotspots, or other suitable techniques.

As the player moves around with the client device 310 in the real world, the positioning module 316 tracks the position of the player and provides the player position information to the gaming module 314. The gaming module 314 updates the player position in the virtual world associated with the game based on the actual position of the player in the real world. Thus, a player can interact with the virtual world simply by carrying or transporting the client device 310 in the real world. In particular, the location of the player in the virtual world can correspond to the location of the player in the real world. The gaming module 314 can provide player position information to the game server 320 over the network 370. In response, the game server 320 may enact various techniques to verify the location of the client device 310 to prevent cheaters from spoofing their locations. It should be understood that location information associated with a player is utilized only if permission is granted after the player has been notified that location information of the player is to be accessed and how the location information is to be utilized in the context of the game (e.g. to update player position in the virtual world). In addition, any location information associated with players is stored and maintained in a manner to protect player privacy.

The localization module 318 provides an additional or alternative way to determine the location of the client device 310. In one embodiment, the localization module 318 receives the location determined for the client device 310 by the positioning module 316 and refines it by determining a pose of one or more cameras of the camera assembly 312. The localization module 318 may use the location generated by the positioning module 316 to select a 3D map of the environment surrounding the client device 310 and localize against the 3D map. The localization module 318 may obtain the 3D map from local storage or from the game server 320. The 3D map may be a point cloud, mesh, or any other suitable 3D representation of the environment surrounding the client device 310. Alternatively, the localization module 318 may determine a location or pose of the client device 310 without reference to a coarse location (such as one provided by a GPS system), such as by determining the relative location of the client device 310 to another device.

The localization module 318 applies one or more trained models (e.g., the localization model) to determine the pose of images captured by the camera assembly 312 relative to the 3D map. The localization model uses one or more inputs (e.g., fundamental matrices, essential matrices, etc.) from a two-view geometry model to determine the pose. Thus, the localization model can determine an accurate (e.g., to within a few centimeters and degrees) determination of the position and orientation of the client device 310.

In some embodiments, some of the functionality of the localization model is performed by a two-view geometry model. The two-view geometry model is a machine learned model. The two-view geometry model may calculate a relative pose between a pair of overlapping images of a scene. The two-view geometry model may be applied to predict one or more errors (e.g., angular translation error and/or rotation error) in the relative pose between the pair of overlapping images. The two-view geometry model may leverage epipolar geometry to compare features of the overlapping images in a dense manner. For example, the two-view geometry model may incorporate the epipolar geometry into an attention layer of a neural network for one or more different fundamental matrix hypotheses. The two-view geometry model may output one or more predicted errors for the pair of images along with a proposed fundamental matrix hypothesis of the different fundamental matrix hypotheses. In some embodiments, the two-view geometry model may select a fundamental matrix associated with the lowest predicted one or more errors. In other embodiments, the localization module 318 selects the fundamental matrix associated with the lowest predicted one or more errors. The client device 310 may display content that accounts for the one or more errors of the selected fundamental matrix. In some embodiments, the localization module 318 may provide the selected fundamental matric and/or the predicted one or more errors to the game server 320 for use in generating content.

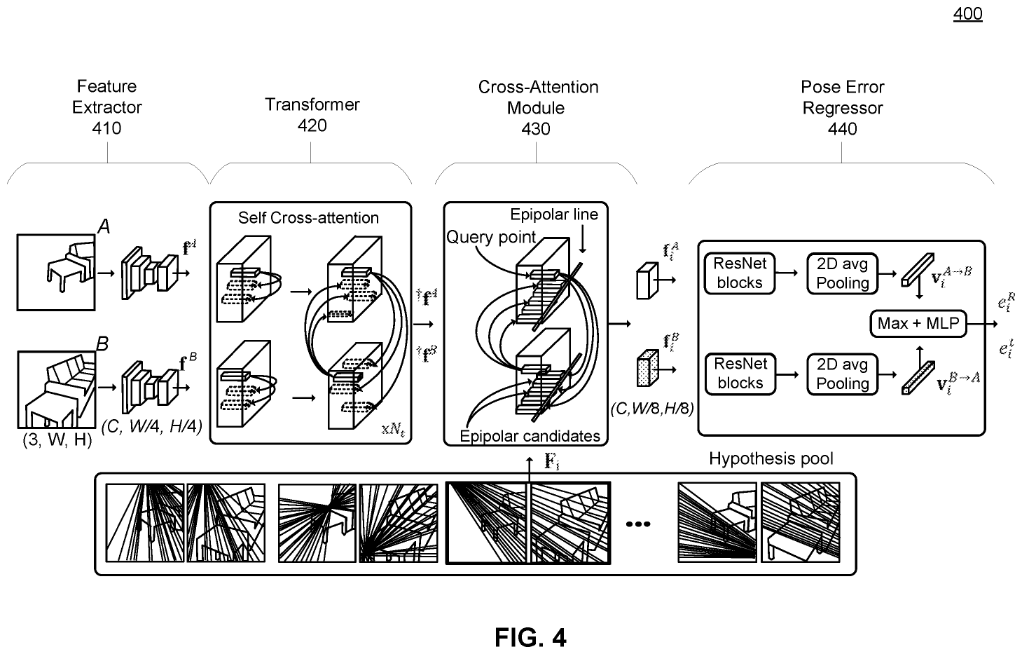

Note that conventional methods often rely on correspondence-based scoring methods that can have problems (e.g., are sensitive to a ratio of inliers, number of correspondences, and accuracy of the keypoints) that result in, e.g., invalid merges in 3D reconstruction models, bad localization services, more expensive steps when finding outliers in pose graphs, etc. In contrast to conventional methods that rely on correspondence-based scoring methods, the embodiments described herein do not use correspondences for scoring, and instead use the two-view geometry model with an epipolar attention mechanism to predict the pose errors of pairs of images. The two-view geometry model is described in detail below with regard to FIG. 4.

The position of the client device 310 can then be tracked over time using dead reckoning based on sensor readings, periodic re-localization, or a combination of both. Having an accurate pose for the client device 310 may enable the gaming module 314 to present virtual content overlaid on images of the real world (e.g., by displaying virtual elements in conjunction with a real-time feed from the camera assembly 312 on a display) or the real world itself (e.g., by displaying virtual elements on a transparent display of an AR headset) in a manner that gives the impression that the virtual objects are interacting with the real world. For example, a virtual character may hide behind a real tree, a virtual hat may be placed on a real statue, or a virtual creature may run and hide if a real person approaches it too quickly.

In this manner, the localization module 318 can determine an accurate (e.g., to within a few centimeters and degrees) determination of the position and orientation of the client device 310. The position of the client device 310 can then be tracked over time using dead reckoning based on sensor readings, periodic re-localization, or a combination of both. Having an accurate pose for the client device 310 may enable the gaming module 314 to present virtual content overlaid on images of the real world (e.g., by displaying virtual elements in conjunction with a real-time feed from the camera assembly 312 on a display) or the real world itself (e.g., by displaying virtual elements on a transparent display of an AR headset) in a manner that gives the impression that the virtual objects are interacting with the real world. For example, a virtual character may hide behind a real tree, a virtual hat may be placed on a real statue, or a virtual creature may run and hide if a real person approaches it too quickly.

The game server 320 includes one or more computing devices that provide game functionality to the client device 310. The game server 320 can include or be in communication with a game database 330. The game database 330 stores game data used in the parallel reality game to be served or provided to the client device 310 over the network 370.

The game data stored in the game database 330 can include: (1) data associated with the virtual world in the parallel reality game (e.g., image data used to render the virtual world on a display device, geographic coordinates of locations in the virtual world, etc.); (2) data associated with players of the parallel reality game (e.g. player profiles including but not limited to player information, player experience level, player currency, current player positions in the virtual world/real world, player energy level, player preferences, team information, faction information, etc.); (3) data associated with game objectives (e.g. data associated with current game objectives, status of game objectives, past game objectives, future game objectives, desired game objectives, etc.); (4) data associated with virtual elements in the virtual world (e.g. positions of virtual elements, types of virtual elements, game objectives associated with virtual elements; corresponding actual world position information for virtual elements; behavior of virtual elements, relevance of virtual elements etc.); (5) data associated with real-world objects, landmarks, positions linked to virtual-world elements (e.g. location of real-world objects/landmarks, description of real-world objects/landmarks, relevance of virtual elements linked to real-world objects, etc.); (6) game status (e.g. current number of players, current status of game objectives, player leaderboard, etc.); (7) data associated with player actions/input (e.g. current player positions, past player positions, player moves, player input, player queries, player communications, etc.); (8) data used by the two-view geometry model (e.g., images, fundamental matrices, predicted angular translation errors, predicated rotational errors, etc.); (9) any other data used, related to, or obtained during implementation of the parallel reality game; (10) or some combination thereof. The game data stored in the game database 330 can be populated either offline or in real time by system administrators or by data received from users (e.g., players), such as from a client device 310 over the network 370.

In one embodiment, the game server 320 is configured to receive requests for game data from a client device 310 (for instance via remote procedure calls (RPCs)) and to respond to those requests via the network 370. The game server 320 can encode game data in one or more data files and provide the data files to the client device 310. In addition, the game server 320 can be configured to receive game data (e.g. player positions, player actions, player input, etc.) from a client device 310 via the network 370. The client device 310 can be configured to periodically send player input and other updates to the game server 320, which the game server uses to update game data in the game database 330 to reflect any and all changed conditions for the game.

In the embodiment shown in FIG. 3, the game server 320 includes a universal game module 322, a commercial game module 323, a data collection module 324, an event module 326, a mapping system 327, and a 3D map store 329. In some embodiments, the game server 320 optionally includes a machine learning training module 328. As mentioned above, the game server 320 interacts with a game database 330 that may be part of the game server or accessed remotely (e.g., the game database 330 may be a distributed database accessed via the network 370). In other embodiments, the game server 320 contains different or additional elements. In addition, the functions may be distributed among the elements in a different manner than described.

The universal game module 322 hosts an instance of the parallel reality game for a set of players (e.g., all players of the parallel reality game) and acts as the authoritative source for the current status of the parallel reality game for the set of players. As the host, the universal game module 322 generates game content for presentation to players (e.g., via their respective client devices 310). The universal game module 322 may access the game database 330 to retrieve or store game data when hosting the parallel reality game. The universal game module 322 may also receive game data from client devices 310 (e.g. depth information, player input, player position, player actions, landmark information, etc.) and incorporates the game data received into the overall parallel reality game for the entire set of players of the parallel reality game. The universal game module 322 can also manage the delivery of game data to the client device 310 over the network 370. In some embodiments, the universal game module 322 also governs security aspects of the interaction of the client device 310 with the parallel reality game, such as securing connections between the client device and the game server 320, establishing connections between various client devices, or verifying the location of the various client devices 310 to prevent players cheating by spoofing their location.

The commercial game module 323 can be separate from or a part of the universal game module 322. The commercial game module 323 can manage the inclusion of various game features within the parallel reality game that are linked with a commercial activity in the real world. For instance, the commercial game module 323 can receive requests from external systems such as sponsors/advertisers, businesses, or other entities over the network 370 to include game features linked with commercial activity in the real world. The commercial game module 323 can then arrange for the inclusion of these game features in the parallel reality game on confirming the linked commercial activity has occurred. For example, if a business pays the provider of the parallel reality game an agreed upon amount, a virtual object identifying the business may appear in the parallel reality game at a virtual location corresponding to a real-world location of the business (e.g., a store or restaurant).

The data collection module 324 can be separate from or a part of the universal game module 322. The data collection module 324 can manage the inclusion of various game features within the parallel reality game that are linked with a data collection activity in the real world. For instance, the data collection module 324 can modify game data stored in the game database 330 to include game features linked with data collection activity in the parallel reality game. The data collection module 324 can also analyze data collected by players pursuant to the data collection activity and provide the data for access by various platforms.

The event module 326 manages player access to events in the parallel reality game. Although the term “event” is used for convenience, it should be appreciated that this term need not refer to a specific event at a specific location or time. Rather, it may refer to any provision of access-controlled game content where one or more access criteria are used to determine whether players may access that content. Such content may be part of a larger parallel reality game that includes game content with less or no access control or may be a stand-alone, access controlled parallel reality game.

The mapping system 327 generates a 3D map of a geographical region based on a set of images. The 3D map may be a point cloud, polygon mesh, or any other suitable representation of the 3D geometry of the geographical region. The 3D map may include semantic labels providing additional contextual information, such as identifying objects tables, chairs, clocks, lampposts, trees, etc.), materials (concrete, water, brick, grass, etc.), or game properties (e.g., traversable by characters, suitable for certain in-game actions, etc.). In one embodiment, the mapping system 327 stores the 3D map along with any semantic/contextual information in the 3D map store 329. The 3D map may be stored in the 3D map store 329 in conjunction with location information (e.g., GPS coordinates of the center of the 3D map, a ringfence defining the extent of the 3D map, or the like). Thus, the game server 320 can provide the 3D map to client devices 310 that provide location data indicating they are within or near the geographic area covered by the 3D map.

The machine learning training module 328 trains machine learning models used within the networked computing environment 300. The networked computing environment 300 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 328 generates the set of parameters for a machine learning model by “training” the machine learning model. Once trained, the machine learning model uses the set of parameters to transform inputs into outputs.

The machine learning training module 328 trains a machine learning model (e.g., the two-view geometry model) based on a set of training examples. Each training example includes input data to which the machine learning model is applied to generate an output. For example, each training example may, include essential matrices, fundamental matrices, depth datasets for one or more camera configurations (e.g., for a single camera, one or more cameras, etc.), or some combination thereof. A depth dataset includes a plurality of images taken with a particular camera configuration, and includes depth information for each of the images. For example, a depth dataset may include millions of images with accompanying depth data, that are annotated with three-dimensional camera poses, surface reconstructions, and instance-level semantic segmentations. In some cases, the training examples also include a label which represents an expected output of the machine learning model. In these cases, the machine learning model is trained by comparing its output from input data of a training example to the label for the training example.

The machine learning training module 328 may apply an iterative process to train a machine learning model whereby the machine learning training module 328 trains the machine learning model on each of the set of training examples. To train a machine learning model based on a training example, the machine learning training module 328 applies the machine learning model to the input data in the training example to generate an output. The machine learning training module 328 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross-entropy loss function. The machine learning training module 328 updates the set of parameters for the machine learning model based on the score generated by the loss function. For example, the machine learning training module 328 may apply gradient descent to update the set of parameters.

In some embodiments, to generate training and validation sets, the machine learning training module 328 extracts keypoint correspondences for every pair of images. The machine learning training module 328 may draw minimal subsets of correspondences randomly and extract a number (e.g., 500) two-view hypotheses (may also be referred to as a hypothesis for a fundamental matrix or essential matrix) for every image pair. For each two-view hypothesis, the machine learning training module 328 may use the two-view geometry model to compute the angular translation (eₜ) error and rotation (e_{R}) error using the ground truth extrinsic and intrinsic parameters. During training, the machine learning training module 328 may have the ground truth hypothesis among the number (e.g., 500) of two-view hypotheses. In batch generation, the machine learning training module 328 may cluster the two-view hypotheses into bins based on the pose error and randomly select a bin, from which one two-view hypothesis is uniformly sampled.

The network 370 can be any type of communications network, such as a local area network (e.g. intranet), wide area network (e.g. Internet), or some combination thereof. The network can also include a direct connection between a client device 310 and the game server 320. In general, communication between the game server 320 and a client device 310 can be carried via a network interface using any type of wired or wireless connection, using a variety of communication protocols (e.g. TCP/IP, HTTP, SMTP, FTP), encodings or formats (e.g. HTML, XML, JSON), or protection schemes (e.g. VPN, secure HTTP, SSL).

This disclosure makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, processes disclosed as being implemented by a server may be implemented using a single server or multiple servers working in combination. Databases and applications may be implemented on a single system or distributed across multiple systems. Distributed components may operate sequentially or in parallel.

In situations in which the systems and methods disclosed access and analyze personal information about users, or make use of personal information, such as location information, the users may be provided with an opportunity to control whether programs or features collect the information and control whether or how to receive content from the system or other application. No such information or data is collected or used until the user has been provided meaningful notice of what information is to be collected and how the information is used. The information is not collected or used unless the user provides consent, which can be revoked or modified by the user at any time. Thus, the user can have control over how information is collected about the user and used by the application or system. In addition, certain information or data can be treated in one or more ways before it is stored or used, so that personally identifiable information is removed. For example, a user's identity may be treated so that no personally identifiable information can be determined for the user.

### Two-View Geometry Model

FIG. 4 is a block diagram of a two-view geometry model 400, according to one or more embodiments. The two-view geometry model 400 may be executed via the localization model 318. The two-view geometry model 400 may estimate the quality of a fundamental matrix hypothesis, Fᵢ, for the two input images (e.g., captured using the one or more cameras of the camera assembly 312), A and B, without relying on correspondences and processing the images directly. Note that while correspondences are not needed to run the two-view geometry model 400, they may be used to generate a pool of fundamental matrices.

The pool of fundamental matrices may be generated using a training pipeline. For example, a keypoint detector may be applied to the two images to compute their keypoint correspondences. The keypoint correspondences may be randomly sampled, and each sample generates a fundamental matrix. The pool of fundamental matrices may be generated by sampling multiple times.

In some embodiments (e.g., in a calibrated setup), the two-view geometry model 400 may compute the score of an essential matrix, Eᵢ, by first obtaining Fᵢ based on their relationship:

$${E}_{i} = {K}_{B}^{T} {F}_{i} {K}_{A} \qquad ( 1 )$$

Where Fᵢ is a fundamental matrix hypothesis from a pool of potential fundamental matrices, K_{B}^{T} is a transposed calibration matrix for a camera that captured image B, and KA is a calibration matrix for the camera that captured image A. The two-view geometry model 400 may include a feature extractor 410, a transformer 420, a cross-attention module 430, and a pose error regressor 440.

The feature extractor 410 is configured to compute a C dimensional feature map (f^{A}) for the image A and a C dimensional feature map (f^{B}) for the image B. The feature extractor 410 may compute the feature maps using a convolutional architecture that follows a Unet-style network design with skip and residual connections. In some embodiments, before feature extraction, the feature extractor 410 center-crops and resizes the input images A and B to a resolution of H×W, where H and W are numbers of pixels. In some embodiments, the computed feature maps are at lower resolution than their corresponding images. In the illustrated example the feature extractor 410 computes feature maps that are ¼ of the resolution of their corresponding image. For example, the input images A and B may have a resolution of 256×256, and the feature extractor 410 outputs a resolution of H/4 and W/4 which in this example corresponds to 64 and 64, respectively, such that the output feature maps are of size 128×64×64 (where 128 corresponds to the channel dimension of the feature map).

As seen in Table 1, the feature extractor 410 may be composed of ResNet (residual neural network)-18 blocks, where every block is based on 3×3 convolutions, batch normalization layers, ReLU activations, and a residual connection. After the ResNet blocks, the feature extractor 410 may upsample the feature maps twice and create skip connections with previous layers following a UNet architecture design. The residual connection may be done between the input to the block and the output. Table 1 illustrates which layers are combined by the skip connections. The Up and Skip conn. refers to an upsampling layer with bilinear interpolation and a skip connection between the input to the layer and the previous layer i. The feature extractor 410 may include a final convolution layer with a batch normalization layer and a Leaky-ReLU activation generates the feature maps f^{A} and f^{B}.

TABLE 1
Example Architecture for Feature Extractor
Feature Extractor

| Layer | Description | Output Shape |
|---|---|---|
| | Input Image | [b, 3, 256, 256] |
| 0 | Conv-BN-ReLU | [b, 128, 256, 256] |
| 1 | ResNet block 1 | [b, 128, 128, 128] |
| 2 | ResNet block 2 | [b, 196, 64, 64] |
| 3 | ResNet block 3 | [b, 256, 32, 32] |
| 4 | ResNet block 4 | [b, 256, 16, 16] |
| 5 | Up and Skip conn. w/layer 3 | [b, 256, 32, 32] |
| 6 | Conv-BN-LeakyReLU | [b, 196, 32, 32] |
| 7 | Up and Skip conn. w/layer 2 | [b, 196, 64, 64] |
| 8 | Conv-BN-LeakyReLU | [b, 128, 64, 64] |

The transformer 420 may use an L multi-head attention transformer architecture and alternate between self and cross-attention blocks to exploit the similarities within and across the feature maps to generate transformed feature maps ^{†}f^{A} and ^{†}f^{B}. Some features from the feature maps may be used to compute a query (q), and potentially different features from the feature maps are used to compute the key (k) and the value (V). q retrieves information from V based on the attention weight computed from the product of q and k. In the self-attention layer, the same feature map builds q, k, and V, meanwhile, in the cross-attention layer, q is computed from a different feature map than k and V. The transformer 420 may interleave the self and cross-attention block N, times, where N, is an integer and t refers to the attention layer. For example, the transformer 420 may use three attention layers (Nₜ=3), where every self and cross-attention layer has eight attention heads. The transformer 420 outputs ^{†}f^{A} and ^{†}f^{B}, which may be stored and reused for every fundamental matrix hypothesis.

To limit the computational complexity, the transformer 420 may use a Linear Transformer. A Linear Transformer may reduce the computational complexity of the original Transformer from O(N²) to O(N) by making use of the associativity property of matrix products and replacing the exponential similarity kernel with a linear dot-product kernel, where O( ) refers to the complexity of the transformer used. Specifically, in a self-attention layer, an input feature map f′ is used to compute q, k and V. The transformer 420 may concatenate the result of the attention layer with the input f′ feature map and pass it through a two-layer multi-layer perceptron (MLP). The output of the MLP is then added to f′ and passed to the next block. In the cross-attention layer, the transformer 320 may repeat the previous process but compute q from one feature map and k and V from the second feature map.

In some embodiments, up to this point, the transformed feature maps ^{†}f^{A} and ^{†}f^{B}, may be cached and reused. Given that two-view geometry model 400 may compute a score for some or all of the fundamental hypothesis pool, this design facilitates a more practical scenario where the overhead of computing additional fundamental matrix scores is small.

In some embodiments, the cross-attention module 430 is configured to embed a two-view geometry into the transformed feature maps. The cross-attention module 430 may take ^{†}f^{A}, ^{†}f^{B}, and Fᵢ to guide the attention between the two transformed feature maps. The cross-attention module 430 may apply cross-attention along an epipolar line. For every query point, the cross-attention module 430 may sample D=45 positions (or some other number) along its corresponding epipolar line, and hence, attention is done only to the D sampled positions. Some sampling positions might be outside of the feature plane, e.g., epipolar line never crosses the feature map. Thus, in those cases, the cross-attention module 430 may pad the positions with zeros, such that they do not contribute when computing the attended features.

The cross-attention module 430 may, for some or all of the fundamental matrix hypothesis Fᵢ, use an epipolar cross-attention mechanism to embed F; together with the transformed feature maps ^{†}f^{A} and ^{†}f^{B}. Every position p^{A}=[u, v] in feature map ^{†}f^{A} has a corresponding epipolar line in ^{†}f^{B} defined as lᵤᵥ^{A→B}=Fᵢ′p^{A}, where p^{A} refers to the homogeneous coordinates of p^{A} and Fᵢ′ is a scaled Fᵢ by a factor (e.g., ¼ or some other amount depending on image and feature map resolutions). As the cross-attention module 430 may analyze potentially hundreds of hypotheses, the resolution of feature maps and transformed feature maps may impact run-time speed. Accordingly, the cross-attention module 430 may define query points, p^{A}=[u, v], with a step sampling of two (or more). This reduces even further a final feature map of the input image (e.g., to a resolution of ⅛ (e.g., (128×32×32)).

So, for every feature ^{†}fᵤᵥ^{A}∈^{†}f^{A} the cross-attention module 430 may sample ^{†}f^{B} at D equidistant locations along the epipolar line lᵤᵥ^{A→B}. The cross-attention module 430 may start sampling where the epipolar line meets the feature map (from left to right) and use bilinear interpolation to produce D features ^{†}fᵤᵥ^{B}. If sampling positions fall outside the image plane, or the epipolar line never crosses the image, the cross-attention module 430 may zero pad the features. Thus, the cross-attention module 430 may build a feature volume ^{†}fᵢ^{B}∈[C, D, W/8, H/8] from the transformed feature map ^{†}f^{B} and Fᵢ. The cross-attention module 430 may use ^{†}f^{A} to compute q, and ^{†}fᵢ^{B} to obtain the k and V, and perform attention along the epipolar candidate points. The cross-attention module 430 may use q, k, and V to obtain epipolar transformed features fᵢ^{A}. For order-invariance, the cross-attention module 430 may also compute fᵢ^{B} by repeating these operations for (^{†}f^{B}, ^{†}f^{A}) pair of feature maps and FT.

The pose error regressor 440 may use the output of the cross-attention module 430 to predict angular translation and rotation errors (eᵢ^{t} and eᵢ^{R}) associated with Fᵢ. For example, the pose error regressor 440 may use ResNet blocks to extract features from fᵢ^{A} and fᵢ^{B}. The pose error regressor 440 may apply a 2-dimensional (2D) average pooling that results in two 1-dimensional (1D) vectors, vᵢ^{A→B} and vᵢ^{B→A}, with size C′. Both 1D vectors may then be merged by a max pooling operator, such that a different order of the input images always produces the same feature vector vᵢ. The pose error regressor 440 may then use a MLP layer to regress the angular translation and rotation errors, eᵢ^{t} and eᵢ^{R}, associated with Fᵢ.

Continuing with the above example, Table 2 provides an example architecture of the pose error regressor 440. The pose error regressor 440 estimates the rotation (eᵢ^{R}) and the angular translation (eᵢ^{t}) errors for images A and B and fundamental matrix Fᵢ. The input to the pose error regressor block is the epipolar transformed features fᵢ^{A} and fᵢ^{B}. As in the feature extractor 410, the ResNet block refers to a ResNet-18 block.

TABLE 2
Example Architecture for Pose Error Regressor
Pose Error Regressor

| Layer | Description | Output Shape |
|---|---|---|
| | Input feature maps (fᵢ^{A} and fᵢ^{B}) | [b, 128, 32, 32] |
| 1 | ResNet block 1 | [b, 128, 16, 16] |
| 2 | ResNet block 2 | [b, 128, 8, 8] |
| 3 | ResNet block 3 | [b, 256, 4, 4] |
| 4 | ResNet block 4 | [b, 512, 2, 2] |
| 5 | 2D Avg. Pooling (vᵢ^{A→B} and vᵢ^{B→A}) | [b, 512, 1, 1] |
| 6 | Max Pooling (vᵢ) | [b, 512, 1, 1] |
| 7 | Conv1x1-BN-ReLU (MLP layer 1) | [b, 512, 1, 1] |
| 8 | Conv1x1-BN-ReLU (MLP layer 2) | [b, 256, 1, 1] |
| 9 | Conv1x1-BN-ReLU (MLP layer 3) | [b, 2] |

Note that the predicted angular translation and rotation errors (eᵢ^{t} and eᵢ^{R}) are for a single fundamental matrix, Fᵢ, from the fundamental matrix hypothesis pool. The two-view geometry model 400 may similarly predict other translation and rotation errors for some or all of the other fundamental matrices from the fundamental matrix hypothesis pool for the images A and B. Note that in some embodiments, for subsequent fundamental matrices (e.g., Fᵢ₊₁, the two-view geometry model 400 may re-use the transformed feature maps for each of the images that were previously calculated using the images A and B. In other embodiments, the two-view geometry model 400 recalculates the transformed feature maps for each different fundamental matrix that is used by the cross-attention module 430.

In some embodiments, the two-view geometry model 400 may rank the predicted errors, and select a fundamental matrix associated with the lowest predicted errors. The selected fundamental matrix and/or associated predicted errors may be used to present content on a client device that accounts for the predicted errors. Additionally or alternatively, the game server 320 may pass the selected fundamental matrix to other algorithms or pipelines such as a 3D map building pipeline, a mesh generation algorithm, or an image sequence to image sequence alignment algorithm, etc.

In some embodiments, the pool of fundamental matrix hypotheses is first reduced by another algorithm or heuristic, such as an inlier correspondence counting heuristic. For example, an initial pool of fundamental matrix hypotheses is generated (e.g., a pool of five hundred fundamental matrices) which is then reduced to a smaller group of hypotheses (e.g., a top ten or some other number smaller than five hundred) by ranking them using an inlier counting heuristic. The smaller group of hypotheses can be used as the pool of fundamental matrix hypotheses for the two-view geometry model.

In some embodiments, the decision to use the two-view geometry model can be conditioned on the number of correspondences extracted for a pair of images. For example, if the number of correspondences is above a first threshold (e.g., one hundred) then a traditional inlier counting heuristic can be used to select the fundamental matrix with the smallest pose error while if the number of correspondences is equal to or less than the threshold then the two-view geometry model may be used to select the fundamental matrix with the smallest pose error.

### Example Methods

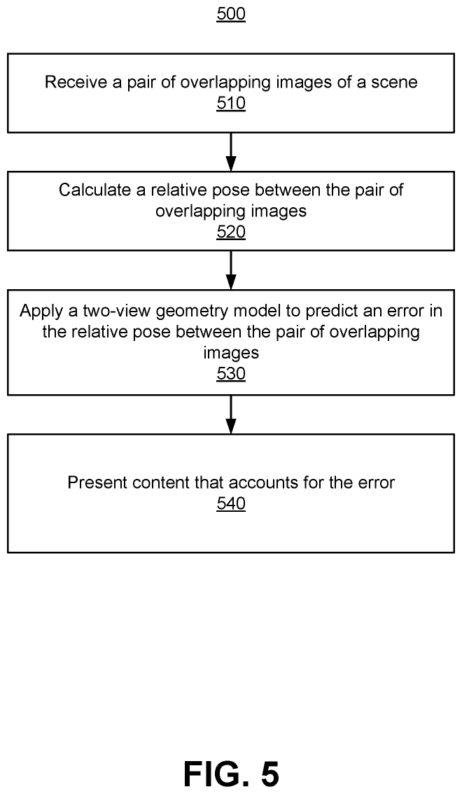

FIG. 5 is a flowchart describing an example method 500 of using two-view geometry scoring in the generation of content, according to one embodiment. The steps of FIG. 5 are illustrated from the perspective of a client device (e.g., the client device 310) performing the method 500. However, some or all of the steps may be performed by other entities or components. For example, in some embodiments, a game server (e.g., the game server 320) may perform some of the steps. In addition, some embodiments may perform the steps in parallel, perform the steps in different orders, or perform different steps.

In the embodiment shown, the client device receives 510 a pair of overlapping images of a scene. The client device may receive the pair of overlapping images from one or more cameras of a camera assembly (e.g., the camera assembly 312).

The client device calculates 520 a relative pose between the paid of overlapping images. In some embodiments, the client device calculates the relative pose using a two-view geometry model. In other embodiments, a localization model may be used to calculate the relative pose.

The client device applies 530 a two-view geometry model to predict an error in the relative pose between the pair of overlapping images. In some embodiments, the applied two-view geometry model is the same model used to calculate the relative pose. The two-view geometry model may compute feature maps for the pair of overlapping images, and using a self-attention layer, and a cross-attention layer form transformed feature maps for each of the feature maps. In some embodiments, the two-view geometry model may downsample the pair of overlapping images to form a pair of downsampled images, and use the pair of downsampled images to compute the feature maps.

The two-view geometry model select a first fundamental matrix hypotheses of a plurality of fundamental matrix hypotheses (e.g., hypothesis pool), and apply cross-attention along epipolar lines to embed the selected fundamental matrix hypothesis into the transformed feature maps to form final feature maps for the pair of overlapping images. The two-view geometry model may predict an angular translation error and a rotation error associated with the selected fundamental matrix hypothesis using the final feature maps. The two view geometry model may repeat this process using the transformed feature maps, but with different fundamental matrix hypotheses from the plurality of fundamental matrix hypotheses to predict their angular translation errors and rotation errors. In some embodiments, the two-view geometry model predicts angular translation error and rotation error for each of the plurality of fundamental matrix hypotheses.

The client device presents 540 content that accounts for the error. In some embodiments, the client device may select a fundamental matrix hypothesis associated with the lowest angular translation error and rotation error that can be applied to the localization model to determine camera pose. The client device may use the determined camera pose to generate content (e.g., augmented reality content) that is presented via the client device.

Note that in some embodiments, some of the above steps (e.g., 510-530) may be performed by the game server. For example, the two-view geometry model may reside on the gaming server, and the client device may provide images captured by a camera assembly to the gaming server. The gaming server may perform steps 510-530 to determine a set of angular translation errors and rotation errors for some or all of the plurality of fundamental matrix hypotheses. The gaming server may select a fundamental matrix from the plurality of fundamental matrix hypotheses based in part on the associated errors (e.g., select the fundamental matrix with the lowest angular translation error and/or rotation error). The gaming server may generate content that accounts for the errors. The gaming server may then provide content for display at the client device accounting for the errors.

### Example Computing System

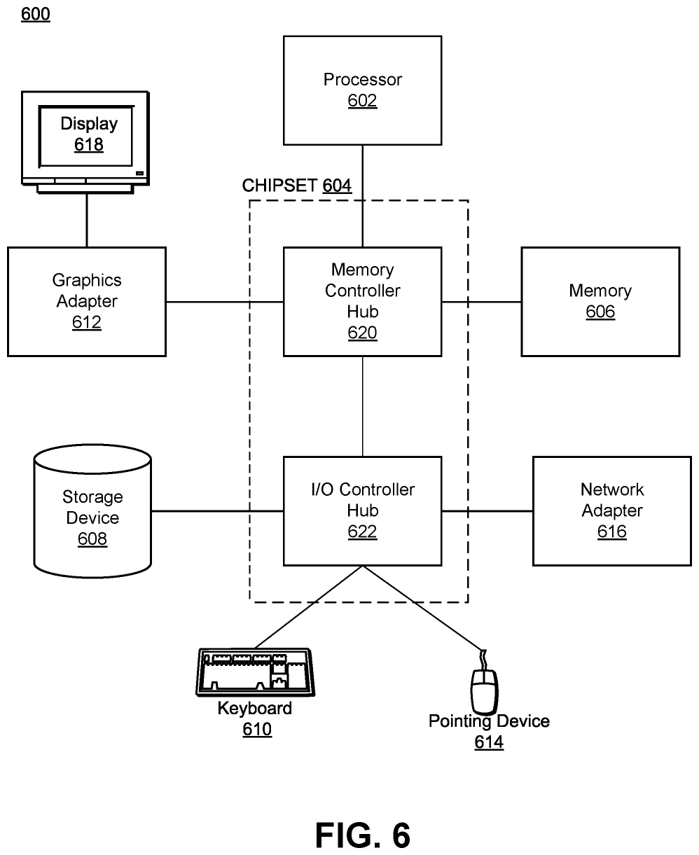

FIG. 6 is a block diagram of an example computer 600 suitable for use as a client device 310 or game server 320. The example computer 600 includes at least one processor 602 coupled to a chipset 604. References to a processor (or any other component of the computer 600) should be understood to refer to any one such component or combination of such components working cooperatively to provide the described functionality. The chipset 604 includes a memory controller hub 620 and an input/output (I/O) controller hub 622. A memory 606 and a graphics adapter 612 are coupled to the memory controller hub 620, and a display 618 is coupled to the graphics adapter 612. A storage device 608, keyboard 610, pointing device 614, and network adapter 616 are coupled to the I/O controller hub 622. Other embodiments of the computer 600 have different architectures.

In the embodiment shown in FIG. 6, the storage device 608 is a non-transitory computer-readable storage medium such as a hard drive, compact disk read-only memory (CD-ROM), DVD, or a solid-state memory device. The memory 606 holds instructions and data used by the processor 602. The pointing device 614 is a mouse, track ball, touch-screen, or other type of pointing device, and may be used in combination with the keyboard 610 (which may be an on-screen keyboard) to input data into the computer 600. The graphics adapter 612 displays images and other information on the display 618. The network adapter 616 couples the computer 600 to one or more computer networks, such as network 370.

The types of computers used by the entities of FIG. 3 can vary depending upon the embodiment and the processing power required by the entity. For example, the game server 320 might include multiple blade servers working together to provide the functionality described. Furthermore, the computers can lack some of the components described above, such as keyboards 610, graphics adapters 612, and displays 618.

### Additional Considerations

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

Any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the elements or components are present unless it is obvious that it is meant otherwise.

Where values are described as “approximate” or “substantially” (or their derivatives), such values should be construed as accurate+/−10% unless another meaning is apparent from the context. From example, “approximately ten” should be understood to mean “in a range from nine to eleven.”

The terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs for a system and a process for providing the described functionality. Thus, while particular embodiments and applications have been illustrated and described, it is to be understood that the described subject matter is not limited to the precise construction and components disclosed. The scope of protection should be limited only by the following claims.

What is claimed is:

1. A computer-implemented method comprising:
receiving a pair of overlapping images of a scene;
calculating a relative pose between the pair of overlapping images;
applying a two-view geometry model to predict an error in the relative pose between the pair of overlapping images; and
providing content for display at a client device accounting for the error.

2. The method of claim 1, wherein the two-view geometry model uses an epipolar attention mechanism to predict the error in the relative pose between the pair of overlapping images.

3. The method of claim 1, further comprising:
computing feature maps for each of the pair of overlapping images; and
using a self-attention layer and a cross-attention layer to form transformed feature maps for each of the feature maps.

4. The method of claim 3, further comprising:
applying cross-attention along epipolar lines to embed a fundamental matrix hypothesis into corresponding transformed feature maps to form final feature maps for the pair of overlapping images.

5. The method of claim 4 wherein applying cross-attention along the epipolar lines to embed the fundamental matrix hypothesis into corresponding transformed feature maps is performed such that a resolution of the final feature maps is less than a resolution of the transformed feature maps.

6. The method of claim 4, wherein applying the two-view geometry model to predict the error in the relative pose between the pair of overlapping images, comprises:
predicting an angular translation error and a rotation error associated with the fundamental matrix hypothesis using the final feature maps.

7. The method of claim 6, wherein the two-view geometry model does not use correspondences to predict the error in the relative pose between the pair of overlapping images.

8. The method of claim 1, further comprising:
identifying a number of correspondences between the pair of overlapping images; and
electing to use the two-view geometry model responsive to the number of correspondences being below a threshold.

9. The method of claim 1, wherein applying the two-view geometry model comprises:
generating a pool of fundamental matrix hypotheses;
reducing the pool of fundamental matrix hypotheses based on rankings of the fundamental matrix hypotheses;
applying the two-view geometry model to calculate a hypothesis error for each fundamental matrix hypothesis in the reduced pool of fundamental matrix hypotheses; and
using a fundamental matrix hypothesis having a lowest hypothesis error to determine the relative pose between the pair of overlapping images, wherein the error in the lowest hypothesis error.

10. A computer program product comprising a non-transitory computer readable storage medium having instructions encoded thereon that, when executed by a processor of a client device, cause the client device to perform operations including:
receiving a pair of overlapping images of a scene;
calculating a relative pose between the pair of overlapping images;
applying a two-view geometry model to predict an error in the relative pose between the pair of overlapping images; and
presenting content that accounts for the error.

11. The computer program product of claim 10, wherein the two-view geometry model is configured to use an epipolar attention mechanism to predict the error in the relative pose between the pair of overlapping images.

12. The computer program product of claim 11, wherein the operations further comprise:
computing feature maps for each of the pair of overlapping images; and
using a self-attention layer and a cross-attention layer to form transformed feature maps for each of the feature maps.

13. The computer program product of claim 11, wherein the operations further comprise:
applying cross-attention along epipolar lines to embed a fundamental matrix hypothesis into corresponding transformed feature maps to form final feature maps for the pair of overlapping images.

14. The computer program product of claim 13, wherein applying the cross-attention along the epipolar lines to embed the fundamental matrix hypothesis into corresponding transformed feature maps is performed such that a resolution of the final feature maps is less than a resolution of the transformed feature maps.

15. The computer program product of claim 13, wherein applying the two-view geometry model to predict the error in the relative pose between the pair of overlapping images further comprises:
predicting an angular translation error and a rotation error associated with the fundamental matrix hypothesis using the final feature maps.

16. The computer program product of claim 15, wherein the two-view geometry model does not use correspondences to predict the error in the relative pose between the pair of overlapping images.

17. A client device comprising:
one or more cameras configured to capture a pair of overlapping images of a scene;
a display configured to present content;
a processor; and
a non-transitory computer readable storage medium having instructions encoded thereon that, when executed by the processor, cause the processor to:
calculate a relative pose between the pair of overlapping images,
apply a two-view geometry model to predict an error in the relative pose between the pair of overlapping images, and
instruct the display to present content, wherein the content accounts for the error.

18. The client device of claim 17, wherein the two-view geometry model is configured to use an epipolar attention mechanism to predict the error in the relative pose between the pair of overlapping images.

19. The client device of claim 17, further comprising instructions that when executed cause the client device to:
compute feature maps for each of the pair of overlapping images; and
use a self-attention layer and a cross-attention layer to form transformed feature maps for each of the feature maps.

20. The client device of claim 17, further comprising instructions that when executed cause the client device to:
apply cross-attention along epipolar lines to embed a fundamental matrix hypothesis into corresponding transformed feature maps to form final feature maps for the pair of overlapping images; and
predict an angular translation error and a rotation error associated with the fundamental matrix hypothesis using the final feature maps.
